(19) United States
(12) Patent Application Publication
(10) Pub. No.: US 2012/0300365 A1
(43) Pub. Date: Nov. 29, 2012

(54) CATHODE ACTIVE MATERIAL, METHOD FOR PREPARING THE SAME, AND LITHIUM ION CAPACITOR INCLUDING THE SAME

(75) Inventors: Sang Kyun Lee, Gyeonggi-do (KR); Bae Kyun Kim, Gyeonggi-do (KR); Ji Sung Cho, Gyeonggi-do (KR)

(73) Assignee: Samsung Electro-Mechanics Co., Ltd., Suwon (KR)

(21) Appl. No.: 13/463,314

(22) Filed: May 3, 2012

(30) Foreign Application Priority Data
May 27, 2011 (KR) 10-2011-0050701

(51) Int. Cl. H01G 9/155; H01G 9/145; H01G 9/042

(52) U.S. Cl. 361/502; 252/182.1; 361/516

(57) ABSTRACT

A cathode active material, a method for preparing the same, and a lithium ion capacitor including the same. The cathode active material has a surface with a porous structure and an inside with an amorphous structure where crystalline phases are not present. The cathode active material according to the present invention has the inside having an amorphous structure where crystal lattices are not contained in a short range order, thereby preventing the lithium ions from being intercalated into the inside of the cathode active material while the anode is pre-doped. The lithium ion capacitor containing the cathode active material having the above structure can maintain a potential difference between the cathode and the anode constantly, thereby obtaining high withstand voltage, high energy density, and high input and output characteristics. Furthermore, a large-capacitance lithium ion capacitor device having excellent reliability of high-speed charging and discharging cycle can be manufactured.

### CROSS REFERENCE(S) TO RELATED APPLICATIONS

This application claims the benefit under 35 U.S.C. Section 119 of Korean Patent Application Serial No. 10-2011-0050701, entitled “Cathode Active Material, Method for Preparing the Same, and Lithium Ion Capacitor Including the Same” filed on May 27, 2011, which is hereby incorporated by reference in its entirety into this application.

### BACKGROUND OF THE INVENTION

1. Technical Field

The present invention relates to a cathode active material, a method for preparing the same, and a lithium ion capacitor including the same.

2. Description of the Related Art

An electric double layer capacitor (EDLC) has better input and output characteristics and higher cycle reliability than a secondary battery such as a lithium ion secondary battery. In recent, the electric double layer capacitor is being successfully developed in connection with environmental problems, and has bright aspects in, for example, a main power and an auxiliary power of an electric vehicle, or an electric power storage device of reproducible energy such as solar power generation or wind power generation. In addition, the electric double layer capacitor is expected to be also utilized as a device capable of outputting large current for a short time in an uninterruptible power supply, which has been increasingly demanded by information technology (IT).

This electric double layer capacitor has a principle in which a pair or plural pairs of polarizable electrodes (anode and cathode), which consist of mainly carbon materials, face each other with a separator therebetween in an electrolyte, and charges are stored in electric double layer formed at interfaces between the polarizable electrodes and the electrolytic solution.

On the other hand, a capacitor using an electrolytic solution containing lithium ions, that is, an asymmetric type lithium ion capacitor storage device is suggested for the purpose of further increasing energy density.

In this lithium ion capacitor storage device containing lithium ions, since a cathode and an anode are different from each other in materials or functions, a cathode activated carbon is used as a cathode active material, and a carbon material capable of easily adsorbing or desorbing the lithium ions in a reversible way is used as an anode active material. A separator is inserted between the cathode and anode, and the resultant structure is immersed in the electrolytic solution containing a lithium salt. The lithium ion capacitor storage device is used while the lithium ions are previously adsorbed on the anode.

With respect to capacitance of the lithium ion capacitor storage device containing lithium ions, negative ions in the electrolytic solution are adsorbed on the cathode and the lithium ions in the electrolytic solution are adsorbed on the anode, at the time of charging. Meanwhile, the negative ions adsorbed on the cathode are desorbed and the lithium ions adsorbed on the anode are desorbed, at the time of discharging.

In the above lithium ion capacitor storage device containing lithium ions, the electric potential of the anode is maintained lower than the electric potential of the electrolytic solution because the lithium ions are previously adsorbed on the anode. For this reason, the lithium ion capacitor storage device containing lithium ions has improvement in withstand voltage and improvement in capacitance thereof itself as compared with the general electric double layer capacitor, thereby obtaining large energy density. In addition, the lithium ion capacitor storage device containing lithium ions can be discharged until the electric potential of the anode is equal to or lower than the electric potential of the electrolytic solution, thereby widening a range of the using voltage, resulting in higher energy density.

However, when the lithium ions are not previously doped (pre-doped) on the anode in a lithium ion capacitor storage device, the electric potential of the anode becomes largely increased later in the discharging, and thus, capacitance of the device is decreased. Therefore, a process of previously adsorbing (doping) the lithium ions on the anode is definitely needed.

Various reports on pre-doping methods of lithium ion are published. For instance, one example of the pre-doping method is that a cathode current collector and an anode current collector each have holes penetrating front and rear surfaces thereof, and lithium ions are supported on an anode within the battery by electrochemical contact between lithium metal and the anode.

Another example of the pre-doping method employs a chemical method. According to this method, an anode and a lithium electrode foil together with non-aqueous electrolytic solution are sealed within a container in advance while the anode and the lithium electrode foil are contacted, and then the temperature is raised.

In general, the whole capacitance of anode is not pre-doped at the time of pre-doping of lithium ion. The reason is that input and output of lithium ion between the cathode and the anode needs to be balanced at the time of charging and discharging. If the whole capacitance of anode is filled with lithium ions, lithium ions in the electrolytic solution is likely to be precipitated as a metal material on a surface of the anode at the time of discharging at 3.0V (potential relative to lithium (Li)) or lower.

In addition, the lithium ions are likely to be inserted into even the cathode material in a discharging area of 3.0V (potential relative to lithium (Li)). The activated carbon used as a general cathode active material is thermally treated in a region of about 700 to 1500° C., and subjected to activation, and thus, it becomes a material of which a surface has increased porosity and an excellent specific surface area. Therefore, the above activated carbon is known to have a form in which a surface thereof has high porosity due to lots of pores and an inside thereof, as shown in FIG. 1, has little pores and crystals.

However, if a structure of an inside of the activated carbon is further enlarged by using a transmission electron microscopy (TEM), it can be seen from FIG. 2, crystal lattices are present within a short range order. In a case where the activated carbon having the above partial crystalline phases in part is used for the anode material, lithium ions are intercalated into the crystal lattices if a voltage at a discharging area of 3.0V or lower is applied to the electrolytic solution where the lithium ions are present.

The intercalation of lithium into the anode material is not problematic if it occurs into a surface of the anode. However, if the intercalation of lithium occurs in crystal lattices present within a short range order, a potential difference between anode and cathode is lowered and long-period reliability becomes largely deteriorated.

### SUMMARY OF THE INVENTION

An object of the invention is to provide a cathode active material for a lithium ion capacitor, which is capable of maintaining a potential difference between a cathode and an anode and suppressing intercalation of lithium ions, thereby exhibiting excellent reliability.

Another object of the present invention is to provide a method for preparing a cathode active material not containing crystal lattices in a short range order in an inside thereof.

Still another object of the present invention is to provide a large-capacitance lithium ion capacitor storage device having high withstand voltage, high energy density, and high input and output characteristics as well as excellent high-speed charging and discharging cycle reliability.

According to an exemplary embodiment of the present invention, there is provided a cathode active material, of which a surface has a porous structure and an inside has an amorphous structure where crystalline phases are not present.

The cathode active material may have a specific area of 1800 to 2500 m²/g.

The crystalline phases may be present in a short range order.

The cathode active material may be a non-graphitizable material of at least one selected from a group consisting of a natural alicyclic compound, a synthetic polymer, activated carbon, carbon black, glass carbon, char, and coal.

The natural alicyclic compound and the synthetic polymer each may be at least one selected from a group consisting of cycloalkane (CₙH₂ₙ) formed by only single bonds, cycloalkene (CₙH₂ₙ₋₂) having a double bond in a ring thereof, and cycloalkyne (CₙH₂ₙ₋₄) having a triple bond.

According to an exemplary embodiment of the present invention, there is provided a method for preparing a cathode active material, including: performing thermal treatment on a cathode active at a temperature of 700° C. or lower, wherein the cathode active material has a surface having a porous structure and an inside having an amorphous structure where crystalline phases are not present.

The thermal treatment may be performed at 500 to 700° C.

The cathode active material may be a non-graphitizable material of at least one selected from a group consisting of a natural alicyclic compound, a synthetic polymer, activated carbon, carbon black, glass carbon, char, and coal.

According to an exemplary embodiment of the present invention, there is provided a lithium ion capacitor, including: a cathode containing the cathode active material; an anode pre-doped; and an electrolytic solution.

The cathode may be maintained at a potential of 3V and the anode may be maintained at a potential of 0V.

The cathode active material may prevent lithium ions from being intercalated into the inside of the cathode active material at the time of pre-doping the anode.

### BRIEF DESCRIPTION OF THE DRAWINGS

FIG. 1 is a transmission electron microscope (TEM) image of an activated carbon;

FIG. 2 is an enlarged image of FIG. 1, showing crystalline phases present in a short range order; and

FIG. 3 is a transmission electron microscope (TEM) image of a cathode active material prepared according to a first exemplary embodiment of the present invention.

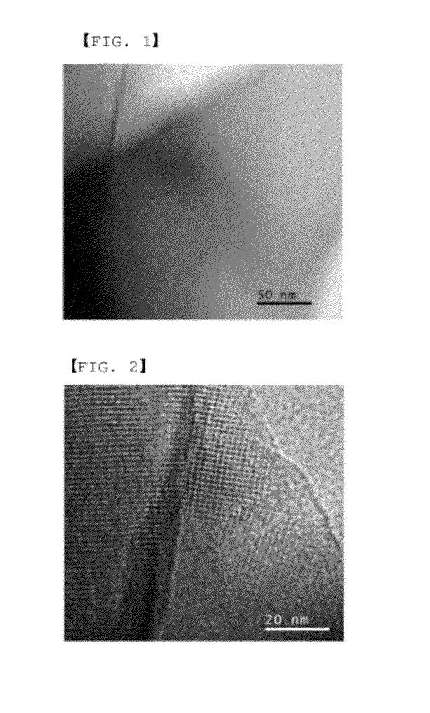

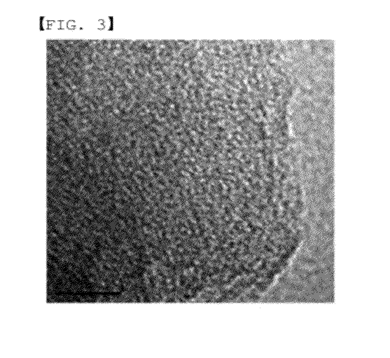

### DESCRIPTION OF THE PREFERRED EMBODIMENTS

Hereinafter, the present invention will be described in more detail as follows, but this does not limit the present invention.

A cathode active material according to the present invention has a surface having a porous structure and an inside having an amorphous structure where crystalline phases are not present.

In other words, the surface of the cathode active material preferably have a porous structure so that negative ions in an electrolytic solution are adsorbed on a cathode at the time of charging and the negative ions are desorbed from the cathode at the time of discharging. However, the inside of the cathode active material does not have pores, and preferably have an amorphous structure where crystal phases are not present in a short range order.

The cathode active material according to the present invention “having a porous structure” means that a specific surface area of the cathode active material measured by a BET method is in a range of 1800 to 2500 m²/g.

Furthermore, the cathode active material according to the present invention has “an amorphous structure where crystalline phases are not present” means that the number of particles having a crystal lattice with size of 0.33 to 0.38 nm based on the D002 plane is 5 or less in a short range order, that is, among 100 particles randomly selected by TEM or the like, in the inside of the cathode active material.

Furthermore, the “crystal lattice” means a crystal lattice that is too small for lithium ions to be intercalated into the crystal lattice, for example, which has a size of 0.33 to 0.38 nm based on the D002 plane.

For this reason, even the short range order in the inside of the cathode active material has an amorphous structure not containing crystal lattices, thereby solving the problem in that lithium ions are intercalated into the crystal lattice present in the short range order to lower a potential difference between an anode and a cathode and long-period reliability is deteriorated, at the time of pre-doping the anode with lithium ions.

As the cathode active material according to the present invention, a non-graphitizable material of at least one selected from a group consisting of a natural alicyclic compound, a synthetic polymer, activated carbon, carbon black, glass carbon, char, and coal is preferably used.

Example of the natural alicyclic compound and the synthetic polymer may be at least one selected from a group consisting of cycloalkane (CₙH₂ₙ) formed by only single bonds, cycloalkene (CₙH₂ₙ₋₂) having a double bond in a ring thereof, and cycloalkyne (CₙH₂ₙ₋₄) having a triple bond, but is not limited thereto.

Since the non-graphitizable material is not easily crystallized during a carbonizing procedure, which is a thermal treatment process performed on the non-graphitizable material for the use as the cathode active material, an inside of the non-graphitizable material can easily create an amorphous structure where little crystal lattices are generated in a short range order.

A method for preparing a cathode active material of a lithium ion capacitor may include performing thermal treatment at a temperature of 700° C. or lower.

That is, according to the present invention, a carbonizing temperature is lowered to the optimal state so that crystals are not generated in the cathode active material. The thermal treatment is preferably performed at 500 to 700° C. If the thermal treatment is performed above 700° C., crystal lattices are likely to be generated undesirably in the short range order in the inside of the cathode active material. The temperature for thermal treatment is kept for 1 to 5 hours in a case where the thermal treatment is performed at 700° C., and for 10 hours or longer in a case where the thermal treatment is performed at about 500° C., thereby achieving uniform carbonization.

After thermal treatment is performed on the cathode active material, an activating procedure, such as, activation with steam, activation with melt KOH, or the like, may be involved. Processes after thermal treatment are performed according to the known methods, and the preparing method thereof is not particularly limited.

Thermal treatment is performed on the non-graphitizable material having difficulty in crystallization at a temperature of 700° C. or lower by the above procedure, thereby preparing a cathode active material in which crystals are not present in the short range order.

In addition, the present invention provides a lithium ion capacitor including a cathode containing the cathode active material having the above structural characteristic, a pre-doped anode, and an electrolytic solution.

In the present invention, when the cathode active material is applied to the cathode of the lithium ion capacitor, lithium ions are prevented from being intercalated into the inside of the cathode active material at the time of pre-doping the anode.

In addition, as for the lithium ion capacitor according to the present invention, the cathode is maintained at a potential of 3V and the anode is maintained at a potential of 0V.

Therefore, the lithium ions are adsorbed on pore portions of a surface of the cathode material instead of crystal lattices in the inside of the anode material even at the time of discharging at 3V or lower, and thus, reversible adsorption and desorption of the lithium ions are possible. Accordingly, energy density and reliability of the lithium ion capacitor can be improved.

Any carbon material that can enable lithium ions to be reversibly adsorbed and desorbed may be used as the anode active material of the present invention. Examples of this active material may include natural graphite, artificial graphite, graphitized meso carbon microbeads (MCMB), graphitized meso carbon fiber (MCF), graphite whisker, graphitized carbon fiber, non-graphitizing carbon, polyacene-based organic semiconductor, carbon nanotube, a carbon composite material of a carbonaceous material and a graphitic material, a pyrolysis material of condensed polycyclic hydrocarbon, such as, a pyrolysis material of Furfuryl alcohol resin, a pyrolysis material of Novolac resin, pitch, coke, and the like. These may be used alone or in combination.

The anode active material has preferably a specific surface area of 1 to 1000 m²/g, which is measured by a BET method. Among the above carbon materials, graphitized meso carbon microbeads (MCMB), graphitized meso carbon fiber (MCF), and non-graphitizing carbon may more be preferable.

Further, the electrolytic solution used at the time of pre-doping the anode and the electrolytic solution contained in the capacitor may be the same kind, and different kinds of electrolyte and electrolytic solution may be separately prepared and used. However, the same kind of electrolyte and electrolytic solution may be used in view of improving production efficiency.

A nonaqueous organic electrolytic solution in which a lithium salt is dissolved is preferable as this electrolytic solution. As an organic solvent to be used, an aprotic solvent is preferable, which is appropriately selected according to solubility, reactivity with electrode, viscosity, and use temperature range of the electrolyte. Specific examples of this organic solvent may include at least one selected from a group consisting of propylene carbonate (PC), diethyl carbonate, ethylene carbonate (EC), sulfolane, acetone nitrile, dimethoxy ethane and tetrahydrofuran, and ethyl methyl carbonate (EMC), but is not limited thereto. Among the organic solvents, a mixed solvent of EC and EMC is preferable, and the blending ratio is preferable about 1:1 to 1:2, but is not limited thereto.

Pre-doping with lithium ions is performed by immersing an electrode, which constitutes a cell where several sheets of anodes and cathodes are stacked with separators therebetween, and an electrode of the metal lithium, and reaching the desired OCP level.

The cathode and the anode may be prepared by the same method as a case where common activated carbon and carbon materials are used. That is, the cathode and the anode of the lithium ion capacitor storage device obtained from the present invention may be prepared, for example, in a plate type or a sheet type, without a binder (a binding agent), but may be molded by using a binder as a shaping agent together with the active material.

Examples of the usable binder may include a fluorine-based resin such as polytetrafluoroethylene (PTFE), polyvinylidene fluoride (PVdF), or the like; a thermoplastic resin such as polyimide, polyamideimide, polyethylene (PE), polypropylene (PP), or the like; a cellulose-base resin such as carboxymethylcellulose (CMC) or the like; or a rubber resin such as styrene-butadiene rubber (SBR) or the like. Among them, the fluorine-based resin is preferable in view of heat resistant property and chemical stability. In particular, PTFE is preferable for the cathode and PVdF is preferable for the anode, in that they are used to facilitate the manufacture of electrodes having excellent liquid absorbing property.

In addition, a material used in conventional electric double-layer capacitors or lithium ion batteries may be used for a cathode current collector. Examples of the material may be at least one selected from a group consisting of aluminum, stainless, titanium, tantalum, and niobium, and aluminum is preferable among them.

In addition, the thickness of the current collector may be about 10 to 300 μm. An example of the current collector may include a metal foil, an etched metal foil, or those having holes penetrating through front and rear surfaces thereof, such as an expanded metal, a punching metal, a net, foam, or the like.

In addition, a material used in conventional electric double-layer capacitors or lithium ion batteries may be used for an anode current collector. Examples of the material may be stainless, copper, nickel, or an alloy thereof, and copper is preferable among them. In addition, the thickness thereof may be about 10 to 300 μm. An example of the current collector may include a metal foil, an etched metal foil, or those having holes penetrating through front and rear surfaces thereof, such as an expanded metal, a punching metal, a net, foam, or the like.

The present invention will be described in detail by the following examples, but the present invention is not limited by the following examples.

### Example 1 Preparation of Cathode Active Material

Thermal treatment was performed on activated carbon at 500° C. for 10 hours. Also, the thermally treated activated carbon was activated by activation with steam to obtain a carbon-based material (particle size 5 to 20 μm) having a specific surface of about 2200 m²/g, which was measured by a BET method.

A transmission electron microscope confirmed a structure of the obtained activated carbon, and the results are tabulated in FIG. 3.

As shown in FIG. 3, it can be confirmed that the cathode active material according to the present invention has an amorphous structure where crystal lattices are not formed in a short range order.

As set forth above, the cathode active material according to the present invention has the inside having an amorphous structure where crystal lattices are not contained in a short range order, thereby preventing the lithium ions from being intercalated into the inside of the cathode active material while the anode is pre-doped.

This structural characteristic can be obtained by maintaining the temperature for thermal treatment low at the time of manufacturing the cathode active material to cut off the possibility that crystals are generated in the short range order in the inside of the active material.

Therefore, according to the present invention, the lithium ion capacitor containing the cathode active material having the above structure can maintain a potential difference between the cathode and the anode constantly, thereby obtaining high withstand voltage, high energy density, and high input and output characteristics. Furthermore, a large-capacitance lithium ion capacitor device having excellent reliability of high-speed charging and discharging cycle can be manufactured.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A cathode active material, of which a surface has a porous structure and an inside has an amorphous structure where crystalline phases are not present.

2. The cathode active material according to claim 1, wherein the cathode active material has a specific area of 1800 to 2500 m²/g.

3. The cathode active material according to claim 1, wherein the crystalline phases are present in a short range order.

4. The cathode active material according to claim 1, wherein the cathode active material is a non-graphitizable material of at least one selected from a group consisting of a natural alicyclic compound, a synthetic polymer, activated carbon, carbon black, glass carbon, char, and coal.

5. The cathode active material according to claim 4, wherein the natural alicyclic compound and the synthetic polymer each are at least one selected from a group consisting of cycloalkane (CₙH₂ₙ) formed by only single bonds, cycloalkene (CₙH₂ₙ₋₂) having a double bond in a ring thereof, and cycloalkyne (CₙH₂ₙ₋₄) having a triple bond.

6. A method for preparing a cathode active material, comprising:
performing thermal treatment on a cathode active at a temperature of 700° C. or lower,
wherein the cathode active material has a surface having a porous structure and an inside having an amorphous structure where crystalline phases are not present.

7. The method according to claim 6, wherein the thermal treatment is performed at 500 to 700° C.

8. The method according to claim 6, wherein the cathode active material is a non-graphitizable material of at least one selected from a group consisting of a natural alicyclic compound, a synthetic polymer, activated carbon, carbon black, glass carbon, char, and coal.

9. A lithium ion capacitor, comprising:
a cathode containing the cathode active material according to claim 1;
an anode pre-doped; and
an electrolytic solution.

10. The lithium ion capacitor according to claim 9, wherein the cathode is maintained at a potential of 3V and the anode is maintained at a potential of 0V.

11. The lithium ion capacitor according to claim 9, wherein the cathode active material prevents lithium ions from being intercalated into the inside of the cathode active material at the time of pre-doping the anode.
